(19) United States
(12) Patent Application Publication
(10) Pub. No.: US 2014/0254081 A1
(43) Pub. Date: Sep. 11, 2014

(54) ELECTRONIC DEVICE HAVING SLIDABLE SCREEN

(71) Applicant: HON HAI PRECISION INDUSTRY CO., LTD., New Taipei (TW)

(72) Inventors: KUAN-YU LIN, New Taipei (TW); HSUAN-YU LIN, New Taipei (TW); LI-CHE LU, New Taipei (TW)

(73) Assignee: HON HAI PRECISION INDUSTRY CO., LTD., New Taipei (TW)

(21) Appl. No.: 14/196,013

(22) Filed: Mar. 4, 2014

(30) Foreign Application Priority Data
Mar. 7, 2013 (TW) 102107966

(51) Int. Cl. G06F 1/16

(52) U.S. Cl. CPC G06F 1/1675
USPC 361/679.26

(57) ABSTRACT

An electronic device includes a base and a cover. The base includes a sliding member slidably mounted thereon. The cover is pivotally mounted on the sliding member. A bobbin is rotatably mounted on the cover. A transmission line is sleeved around the bobbin. One end of the transmission line is connected to the cover, and another end of the transmission line is connected to the base. A position of the cover relative to the base is adjustable by sliding the sliding member on the base, and the transmission line wraps on or off the bobbin when the sliding member slides on the base.

### TECHNICAL FIELD

The disclosure generally relates to electronic devices, and more particularly to an electronic device having a slidable screen.

### BACKGROUND

Electronic devices, such as notebook computers, are widely used. The notebook computer often includes a base and a screen rotatably mounted on the base via a rotating structure. To use the notebook computer, the screen rotates relative to the base to an open position. However, because the rotating structure is immovable relative to the base, the screen can only rotate to one position on the base. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of an electronic device.

FIG. 2 is an enlarged view of a circled portion II of FIG. 1.

FIG. 3 is an enlarged view of a sliding member of the electronic device of FIG. 1.

FIG. 4 is an assembled view of the electronic device of FIG. 1 in one position.

FIG. 5 is the assembled view of the electronic device of FIG. 1 in another position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

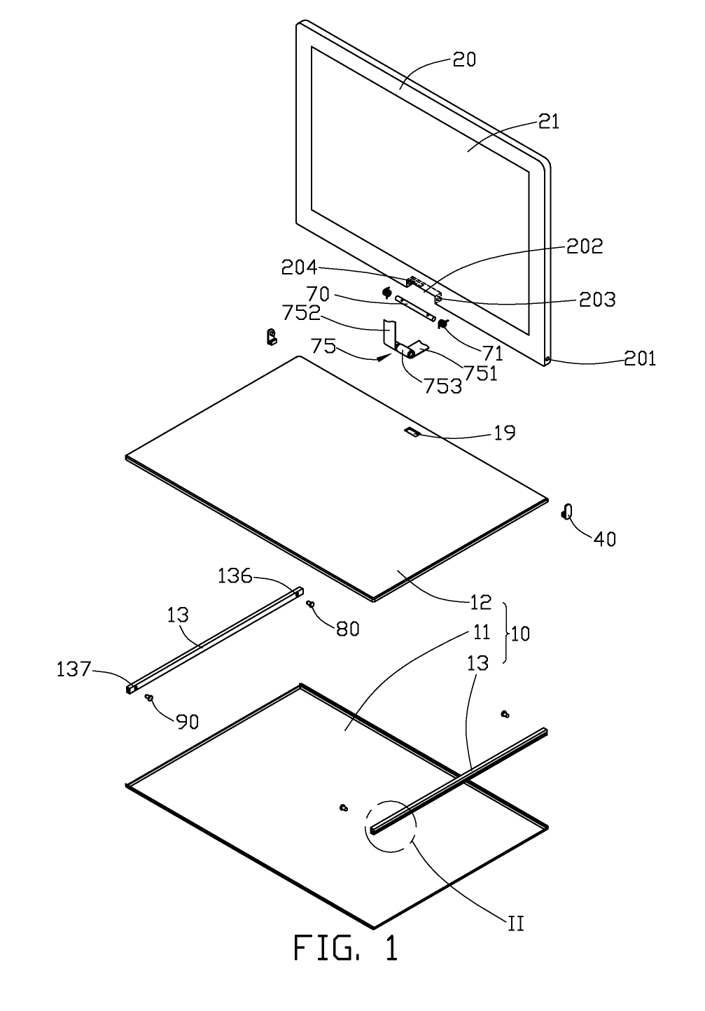

FIG. 1 shows one embodiment of an electronic device. The electronic device includes a base 10 and a cover 20. The cover 20 includes a screen 21. In one embodiment, the screen 21 is a touch screen.

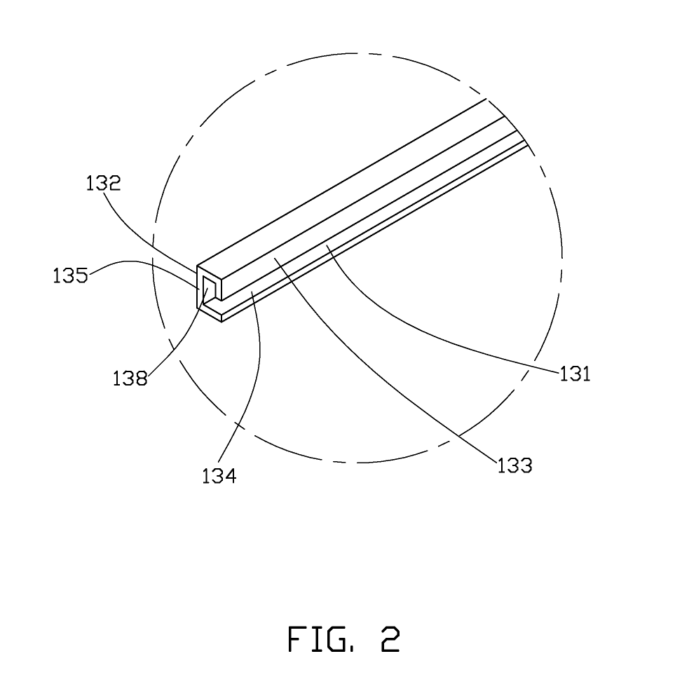

Referring to FIGS. 1 and 2, the base 10 includes a bottom plate 11, a seat 12, and two slide rails 13. The seat 12 and the two slide rails 13 can be mounted on the bottom plate 11. The two slide rails 13 are mounted to opposite edges of the seat 12. Each slide rail 13 includes a first side 131 and a second side 132. A restricting strip 133 is set on the first side 131 of the slide rail 13. An opening 134 is defined below the restricting strip 133. A mounting wall 135 is set on the second side 132 of the slide rail 13. A first positioning hole 136 and a second positioning hole 137 are defined in the mounting wall 135. A slide way 138 is defined between the first side 131 and the second side 132, and communicates with the opening 134. A first slot 19 is defined in the base 10.

A first positioning pillar 80 can be mountably received in the first positioning hole 136. A second positioning pillar 90 can be mountably received in the second positioning hole 137.

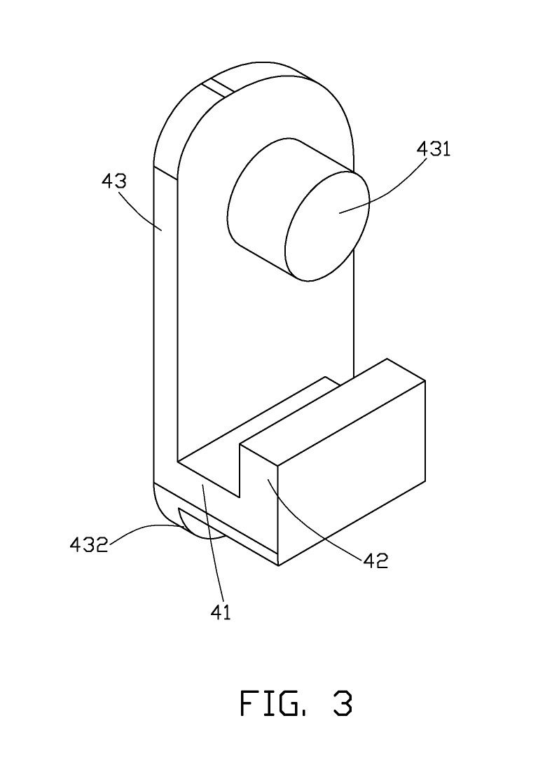

Referring to FIGS. 1 and 3, each slide rail 13 can slidably receive a sliding member 40 therein. The sliding member 40 includes a connecting piece 41, a restricting piece 42, and a mounting piece 43. The restricting piece 42 and the mounting piece 43 are connected substantially perpendicularly to opposite edges of the connecting piece 41. The restricting piece 42 is substantially parallel to the mounting piece 43. A height of the restricting piece 42 is larger than a height of the opening 134. A pivot pin 431 is formed on the mounting piece 43. A bottom of the mounting piece 43 forms an arced sliding surface 432.

The cover 20 defines a pair of pivot holes 201. A substantially central portion of a bottom portion of the cover 20 defines a cutout 202. The cover 20 defines a pair of receiving holes 203 communicating with two ends of the cutout 202, and a second slot 204 communicating with a back wall of the cutout 202.

A bobbin 70 can be received in the cutout 202, such that opposite ends of the bobbin 70 can be rotatably received in the pair of receiving holes 203. A spring 71 can be attached to each end of the bobbin 70. One end of the spring 71 is fixed on the bobbin 70, and another end of the spring 71 is fixed on the cover 20.

A transmission line 75 includes a first portion 751, a second portion 752, and a connection portion 753. The first portion 751 and the second portion 752 are connected to different parts of the connection portion 753. The connection portion 753 is sleeved around the bobbin 70. The first portion 751 extends through the first slot 19 of the base 10 to be electrically connected to the base 10. The second portion 752 extends through the second slot 204 of the cover 20 to be electrically connected to the screen 21.

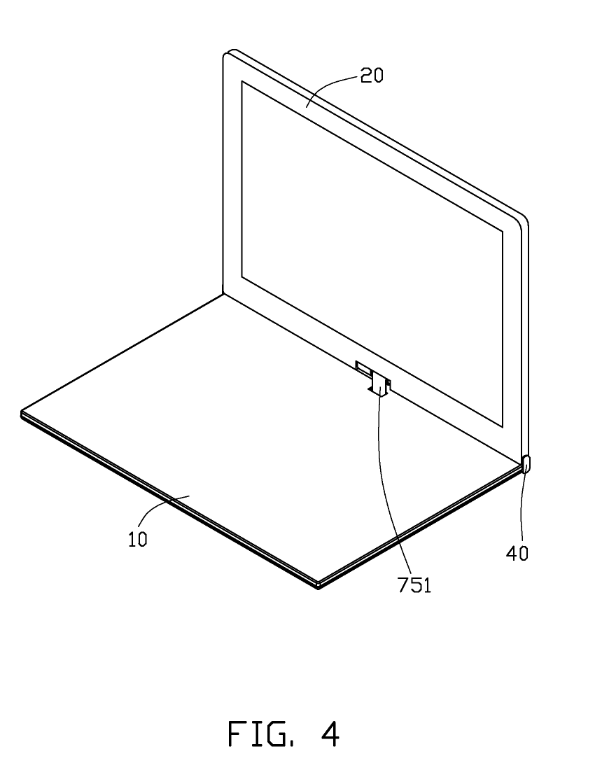

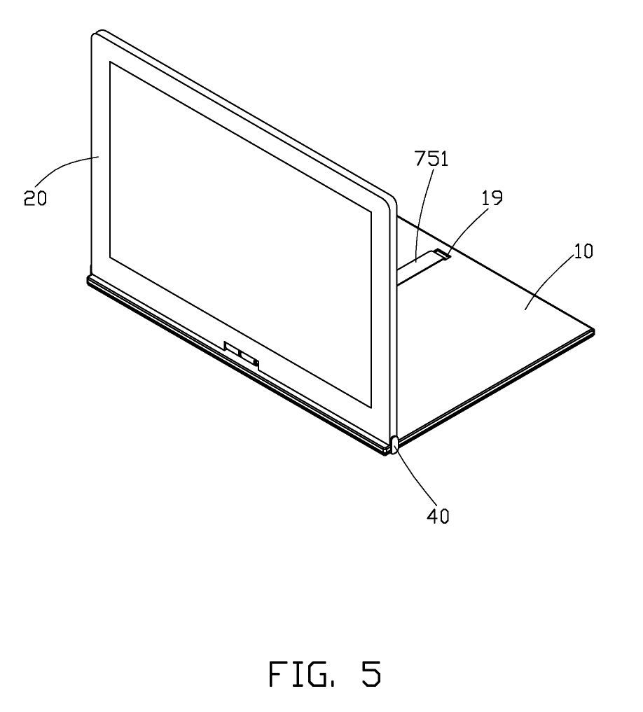

Referring to FIGS. 1 to 5, in assembly, the restricting pieces 42 of the sliding members 40 are slidably received in the corresponding slide ways 138 of the slide rails 13. The restricting piece 42 resists the restricting strip 133 to be prevented from moving out of the slide way 138. The first positioning pillar 80 is received in the first positioning hole 136, and the second positioning pillar 90 is received in the second positioning hole 137. The connecting piece 41 of the sliding member 40 is received in the opening 134 and can slide along the opening 134. The sliding rails 13 are mounted to the opposite edges of the seat 12, and the seat 12 is mounted on the bottom plate 11. The pivot pins 431 of the sliding members 40 are pivotally received in the corresponding pivot holes 201 of the cover 20. Therefore, the electronic device is assembled. In a first position, the sliding members 40 are at a side of the first positioning pillars 80 toward a first end of the slide rails 13.

In use, the cover 20 rotates on the base 10 to expose the screen 21. To slide the cover 20 along the slide rails 13, the cover 20 is pushed to slide the sliding members 40 over the first positioning pillars 80. The sliding members 40 slide along the slide way 138, until the sliding members 40 abut the second positioning pillars 90. The second positioning pillar 90 blocks the sliding member 40 to position the sliding member 40 and the cover 20 in a second position. Simultaneously, the first portion 751 of the transmission line 75 is pulled from the bobbin 70. The bobbin 70 rotates in the cutout 202 to compress the spring 71. When the sliding member 40 and the cover 20 slides from the second position back to the first position, the spring 71 rebounds to wrap the first portion 751 on the bobbin 70.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An electronic device, comprising:
a base comprising a sliding member slidably mounted thereon;
a cover pivotally mounted on the sliding member;
a bobbin rotatably mounted on the cover; and
a transmission line sleeved around the bobbin, one end of the transmission line being connected to the cover, and another end of the transmission line being connected to the base,
wherein a position of the cover relative to the base is adjustable by sliding the sliding member on the base, and the transmission line wraps on or off the bobbin when the sliding member slides on the base.

2. The electronic device of claim 1, wherein a second portion of the transmission line is connected to the cover, and a first portion of the transmission line is wrapped on the bobbin and connected to the base.

3. The electronic device of claim 2, wherein each of the first portion and the second portion is connected to a connection portion of the transmission line.

4. The electronic device of claim 2, wherein a spring is jacked on the bobbin, one end of the spring abuts on the bobbin, and another end of the spring abuts on the cover.

5. The electronic device of claim 1, wherein a slide rail is mounted on the base, and the sliding member is slidably received in the slide rail.

6. The electronic device of claim 5, wherein a restricting strip is located on a first side of the slide rail, an opening is defined below the restricting strip, the sliding member comprises a restricting piece and a connecting piece, the restricting piece is located in the slide rail and abuts the restricting piece, and the connecting piece is slidable in the opening.

7. The electronic device of claim 6, wherein a slide way is defined between the first side and a second side of the slide rail, and the restricting piece is located in the slide way.

8. The electronic device of claim 7, wherein a mounting wall is formed on the second side, the mounting wall defines a first positioning hole and a second positioning hole, a first positioning pillar is mounted in the first positioning hole, a second positioning pillar is mounted in the second positioning hole, and each of the first positioning pillar and the second positioning pillar is configured to block the sliding member from sliding in the sliding rail.

9. The electronic device of claim 7, wherein the sliding member comprises a mounting piece, the mounting piece comprises a pivot pin, and the cover defines a pivot hole, and the pivot pin is pivotally inserted into the pivot hole.

10. The electronic device of claim 9, wherein the mounting piece and the restricting piece are perpendicularly connected to opposite edges of the connecting piece.

11. An electronic device, comprising:
a base comprising a first positioning pillar and a second positioning pillar;
a sliding member slidably mounted on the base and configured to slide between the first positioning pillar and the second position pillar; and
a cover mounted on the sliding member;
wherein each of the first positioning pillar and the second positioning pillar is configured to block the sliding member from sliding on the base.

12. The electronic device of claim 11, wherein a bobbin is rotatably mounted on the cover, a transmission line is wrapped on the bobbin, one end of the transmission line is connected to the cover, and another end of the transmission line is connected to the base, and the transmission line is configured to be wrapped on or off the bobbin when the sliding member slides on the base.

13. The electronic device of claim 12, wherein a second portion of the transmission line is connected to the cover, and a first portion of the transmission line is wrapped on the bobbin and connected to the base.

14. The electronic device of claim 13, wherein each of the first portion and the second portion are connected to a connection portion of the transmission line.

15. The electronic device of claim 13, wherein a spring is jacked on the bobbin, one end of the spring abuts on the bobbin, and another end of the spring abuts on the cover.

16. The electronic device of claim 11, wherein a slide rail is mounted on the base, and the sliding member is slidably received in the slide rail.

17. The electronic device of claim 16, wherein a restricting strip is located on a first side of the slide rail, an opening is defined below the restricting strip, the sliding member comprises a restricting piece and a connecting piece, the restricting piece is located in the slide rail and abuts the restricting piece, and the connecting piece is slidable in the opening.

18. The electronic device of claim 17, wherein a slide way is defined between the first side and a second side of the slide rail, and the restricting piece is located in the slide way.

19. The electronic device of claim 18, wherein a mounting wall is formed on the second side, the mounting wall defines a first positioning hole and a second positioning hole, the first positioning pillar is mounted in the first positioning hole, and the second positioning pillar is mounted in the second positioning hole.

20. The electronic device of claim 11, wherein the sliding member comprises a mounting piece, the mounting piece comprises a pivot pin, and the cover defines a pivot hole, and the pivot pin is pivotally inserted into the pivot hole.
